(19) United States
(12) Patent Application Publication
(10) Pub. No.: US 2025/0183024 A1
(43) Pub. Date: Jun. 5, 2025

(54) SYSTEM AND METHOD FOR CONTROLLING THE FLOW OF AEROSOLS

(71) Applicant: University of Hawaii, Honolulu, HI (US)

(72) Inventors: Tyler R. RAY, Honolulu, HI (US); Roxanne Kate BALANAY, Honolulu, HI (US)

(21) Appl. No.: 19/035,791

(22) Filed: Jan. 23, 2025

Related U.S. Application Data
(63) Continuation-in-part of application No. 18/822,055, filed on Aug. 30, 2024.
(60) Provisional application No. 63/536,075, filed on Sep. 1, 2023.

(51) Int. Cl. H01J 49/04; H01J 49/02; H01J 49/42

(52) U.S. Cl. CPC H01J 49/0422; H01J 49/022; H01J 49/4225

(57) ABSTRACT

A system and method for controlling the flow of aerosols. In some embodiments, a system includes a fluid channel, an actuator, and an actuator drive circuit. The actuator and the actuator drive circuit may be configured to impart vibrations, to a wall of the fluid channel, which produce waves in a gas in the fluid channel and cause aerosols in the gas to be nonuniformly distributed across the interior of the fluid channel, the waves producing a pressure pattern including a plurality of nodes or a plurality of antinodes within the fluid channel.

### CROSS-REFERENCE TO RELATED APPLICATION(S)

The present application is a continuation in part of U.S. patent application Ser. No. 18/822,055, filed Aug. 30, 2024, entitled “ACOUSTIC-ENABLED AEROSOL SEPARATOR”, which claims priority to and the benefit of U.S. Provisional Application No. 63/536,075, filed Sep. 1, 2023, entitled “Acoustic-Enabled Aerosol Separator”, the entire content of which is incorporated herein by reference.

### FIELD

One or more aspects of embodiments according to the present disclosure relate to aerosols, and more particularly to a system and method for controlling the flow of aerosols.

### BACKGROUND

Aerosols are present in gases in various naturally occurring environments, and gases containing aerosols may also be artificially generated, e.g., for the purpose of performing analysis of such aerosols or of reaction products (e.g., intermediate reaction products).

It is with respect to this general technical environment that aspects of the present disclosure are related.

### SUMMARY

According to an embodiment of the present disclosure, there is provided a system, including: a fluid channel; an actuator; and an actuator drive circuit, the actuator and the actuator drive circuit being configured to impart vibrations, to a wall of the fluid channel, which produce waves in a gas in the fluid channel and cause aerosols in the gas to be nonuniformly distributed across the interior of the fluid channel, the waves producing a pressure pattern including a plurality of nodes or a plurality of antinodes within the fluid channel.

In some embodiments, the waves produce a pressure pattern including a node within the fluid channel.

In some embodiments, the waves produce a pressure pattern including an antinode within the fluid channel.

In some embodiments, the waves produce a pressure pattern including three nodes within the fluid channel.

In some embodiments, the waves produce a pressure pattern including three antinodes within the fluid channel.

In some embodiments, the actuator is a piezoelectric actuator.

In some embodiments, the fluid channel is cylindrical.

In some embodiments, the actuator is a cylindrical piezoelectric actuator.

In some embodiments, the actuator drive circuit is configured to produce a signal with a frequency between 100 KHz and 1.5 MHz.

According to an embodiment of the present disclosure, there is provided a system, including: a fluid channel; an actuator; an actuator drive circuit; and an analytic instrument, the actuator and the actuator drive circuit being configured to impart vibrations, to a wall of the fluid channel, which produce waves in a gas in the fluid channel and cause aerosols in the gas to be nonuniformly distributed across the interior of the fluid channel, and an outlet of the fluid channel being connected to the analytic instrument.

In some embodiments, the analytic instrument includes a mass spectrometer.

In some embodiments, the mass spectrometer is a quadrupole ion trap mass spectrometer.

In some embodiments, the analytic instrument includes a system for performing crystallography.

In some embodiments, the waves produce a pressure pattern including a node within the fluid channel.

In some embodiments, the waves produce a pressure pattern including an antinode within the fluid channel.

In some embodiments, the waves produce a pressure pattern including three antinodes within the fluid channel.

In some embodiments, the actuator is a piezoelectric actuator.

In some embodiments, the fluid channel is cylindrical.

In some embodiments, the actuator is a cylindrical piezoelectric actuator.

In some embodiments, the actuator drive circuit is configured to produce a signal with a frequency between 100 KHz and 1.5 MHz.

### BRIEF DESCRIPTION OF THE DRAWINGS

These and other features and advantages of the present disclosure will be appreciated and understood with reference to the specification, claims, and appended drawings wherein:

FIG. 1A is a schematic drawing of a standing wave and the control of aerosol particles it may achieve, according to an embodiment of the present disclosure;

FIG. 1B includes two equations for calculating forces on aerosol particles, according to an embodiment of the present disclosure;

FIG. 1C is a perspective view of a portion of an acoustic-focusing enabled system for aerosol control, according to an embodiment of the present disclosure;

FIG. 2A is a side cross-sectional view of a portion of an acoustic-focusing enabled system for aerosol control, according to an embodiment of the present disclosure;

FIG. 2B is an end cross-sectional view of a portion of an acoustic-focusing enabled system for aerosol control, according to an embodiment of the present disclosure;

FIG. 3A is a schematic cross-sectional view of a stream of particles in a fluid channel, according to an embodiment of the present disclosure;

FIG. 3B is a schematic cross-sectional view of a plurality of streams of particles in a fluid channel, according to an embodiment of the present disclosure;

FIG. 3C is a schematic cross-sectional view of a plurality of streams of particles in a fluid channel, according to an embodiment of the present disclosure;

FIG. 3D is a schematic cross-sectional view of a plurality of streams of particles in a fluid channel, according to an embodiment of the present disclosure;

FIG. 3E is a schematic cross-sectional view of a plurality of streams of particles in a fluid channel, according to an embodiment of the present disclosure;

FIG. 3F is a schematic cross-sectional view of a stream of particles in a fluid channel, according to an embodiment of the present disclosure;

FIG. 4A is a schematic drawing of a separator, according to an embodiment of the present disclosure;

FIG. 4B is a schematic drawing of a combiner, according to an embodiment of the present disclosure;

FIG. 5 is a system level diagram of a system for controlling and analyzing aerosol particles, according to an embodiment of the present disclosure;

### DETAILED DESCRIPTION

The detailed description set forth below in connection with the appended drawings is intended as a description of exemplary embodiments of a system and method for controlling the flow of aerosols provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

Instrumentation for aerosol mass spectrometry (AMS) may enable investigation of complex problems, e.g., problems in the Earth's atmospheric chemistry either in laboratory chamber experiments or in combination with aircraft and high-altitude balloons. However, some aerosol mass spectrometry instruments are large and consume a great deal of power. Measuring the composition of aerosols may be challenging because aerosols may represent only a minute fraction of the mass of the gases (e.g., atmospheric gases) in which they are embedded. Mechanical separation with filters may be impractical because aerosols may be volatile or chemically unstable. Aerodynamic lenses may be used to concentrate aerosols, but such lenses may not necessarily segregate aerosols from the dominant gas phase to facilitate aerosol sample injection into a mass spectrometry instrument (such as a quadrupole ion trap mass spectrometer (QIT-MS)) for analysis of chemical composition.

High-yield lenses may enable mass spectrometry systems to characterize aerosols with greater than parts-per-billion sensitivity; however, operation may require constant outside pressure. In some applications (e.g., planetary probe applications), sample injection of aerosols into a mass spectrometry instrument presents additional engineering challenges beyond the necessity for robust long-duration operation, minimized modes of failure, and restricted energy and mass budgets.

As such, some embodiments include an ultra-compact acoustic-focusing enabled system for aerosol control (e.g., an acoustic-focusing enabled aerosol separator (AF-AS)) capable of tolerating broad external pressure changes while handling various aerosols with precise, deterministic control over aerosol spatial position within moving fluid. The use of such an acoustic separator may enable the segregation of the aerosol and gas mixture prior to entering an analytic instrument (e.g., an instrument including an aerodynamic lens system followed by a mass spectrometer), thereby enhancing the transmission efficiency to the detector of a mass spectrometry system. Such a system for aerosol control may also be suitable for analyzing acidic aerosols.

An acoustic-focusing enabled system for aerosol control may be used as a gaseous sample inlet for any mass spectrometer for analyzing a gas containing suspended aerosols, including liquid, icy, and metallic particles. In such an application, the acoustic-focusing enabled system for aerosol control may segregate aerosols from a carrier gas using an applied acoustic field. The acoustic-focusing enabled system for aerosol control may be tolerant to changes in atmospheric pressure of up to three orders of magnitude while performing high-yield segregation of aerosols from the dominant gas phase. When attached to a mass spectrometer, it may enable in-situ real-time studies of chemical composition of aerosols at parts-per-billion sensitivity.

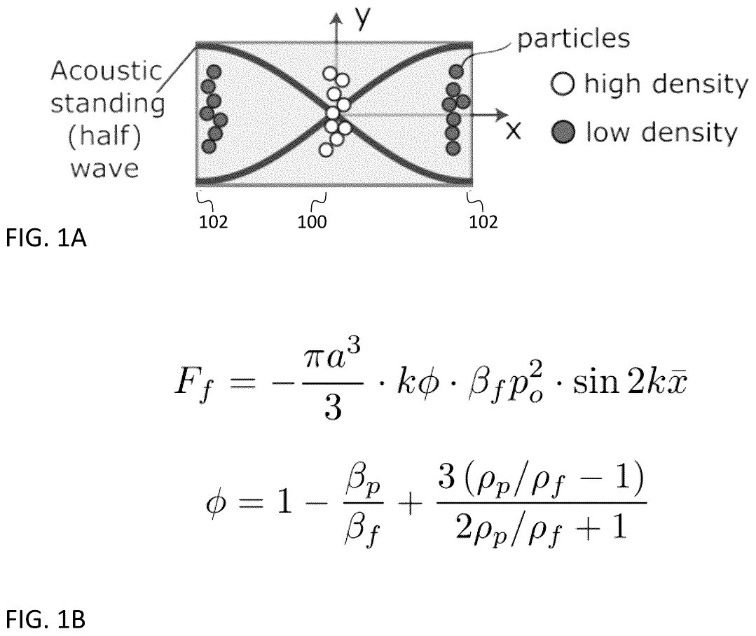

Acoustic forces created by standing pressure waves may be used to increase the density and alignment of particles. Acoustic focusing, or “acoustophoretic focusing,” may be achieved by a standing pressure wave that has a pressure pattern producing a time-averaged force on the particles (e.g., the aerosols) that drives them to pressure nodes or antinodes. This principle is shown in FIG. 1A, which is a schematic one-dimensional drawing of an acoustic standing wave with a node 100 and two antinodes 102 (each antinode being at a local maximum of the amplitude of the pressure oscillations due to the acoustic standing wave). FIG. 1B shows equations that may used to calculate the time-averaged focusing force F_{f}, with β being compressibility, ρ being density, and the subscripts p and fidentifying (except in the symbol F_{f}) properties of the particles and fluid, respectively, k being the angular wavenumber (k=2π/λ, with λ begin the wavelength), and α being the radius of the particle. As shown, each particle may tend to move toward the nearest node or the nearest antinode, depending on the properties of the particle and the surrounding medium.

Referring to FIG. 1C, the technique may use a fluid channel 105 (e.g., a nozzle). In FIG. 1C, the fluid channel 105 is formed by a sheet of silicon 110 with a trench etched into it, the trench being covered by a sheet of glass 115 bonded to the sheet of silicon 110. The inner surface or surfaces of the fluid channel 105 may provide boundary conditions (e.g., the surfaces may reflect acoustic waves) resulting in transverse modes (e.g., eigenmodes) at certain resonant frequencies, which may depend on the dimensions of the fluid channel 105 and the speed of sound in the fluid (e.g., in the gas) in the fluid channel 105. A transverse mode of the fluid channel 105 may be driven by an actuator, e.g., by a piezoelectric actuator 120. Driving the piezoelectric actuator 120 at such a frequency (which may be referred to as the acoustic drive frequency, and which may be between 10 KHz and 10 MHz or more, e.g., between 500 kHz and 900 kHz) may then establish a standing wave in pressure that applies a force (which may be referred to as a “primary focusing force”) to particles such that they are transported from random positions within the fluid channel 105 to a node or to an antinode of the standing wave.

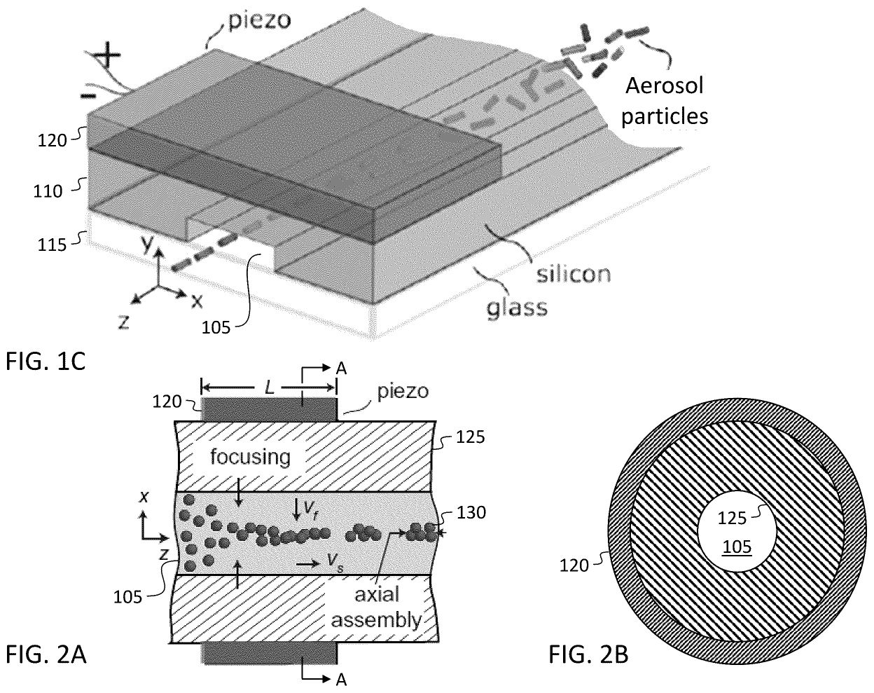

For example, as illustrated in FIG. 2A and in FIG. 2B (which is a cross-sectional view along the line A-A of FIG. 2A), for a fluid channel 105 with a circular cross-section, in a tube 125, the acoustic drive frequency may be selected to match an eigenmode determined in part by the inner diameter of the fluid channel 105 (which may be the inner diameter (or “inside diameter”) of the tube 125), and the particles 130 may be driven to the centerline of the fluid channel 105 (as shown, for gas flowing from right to left, in FIG. 2A). This may collimate the particles 130 by confining them to the center of the fluid channel 105. Such forces may be active over large distances and may be insensitive to chemistry, and may lack the specific requirements in surface functionalization, solution chemistries, or electromagnetic properties specified for some field-assembly methods. As a result, the acoustic-focusing enabled system for aerosol control may provide a material-agnostic method of controlling the spatial position of particles in a fluid medium. When a round (cylindrical) tube 125 (e.g., a tube having an outer surface and an inner surface both of which are circular in a cross-sectional view such as FIG. 2B) is used, the piezoelectric actuator 120 may also be a cylindrical tube, fitting closely over the outer surface of the tube 125 that defines the fluid channel 105.

In some embodiments, the acoustic-focusing enabled system for aerosol control may be suitable for controlling the motion of aerosols at a density between 1 particle per liter (or less) and 10,000 particles per cm³, e.g., between 10 particles cm⁻³, and 100 particles cm⁻³. The acoustic-focusing enabled system for aerosol control may also be suitable for controlling the motion of aerosols with particle sizes between 250 nm and 10 μm or more.

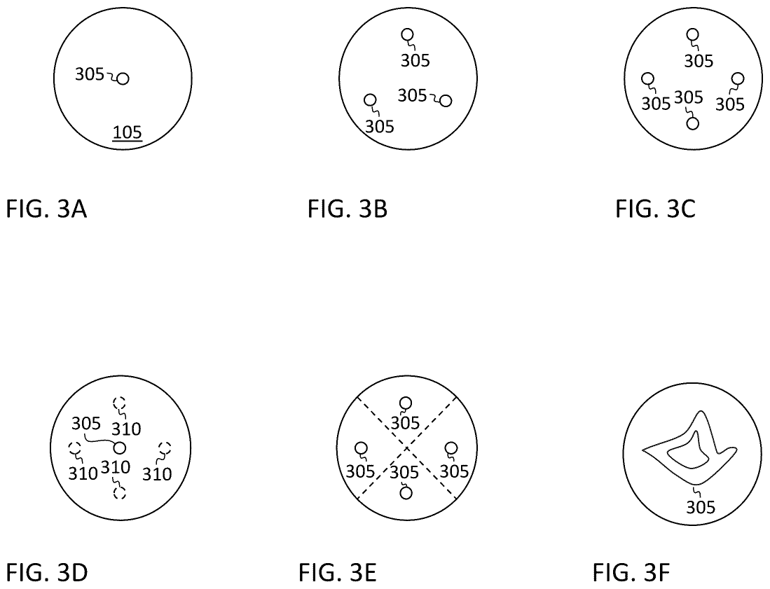

At different resonant frequencies, the transverse mode patterns formed may produce different node and antinode configurations. For example, FIG. 3A shows a particle stream 305 centered in a cylindrical fluid channel 105, as a result of (i) there being a node in the center of the fluid channel 105 and the particles being ones that tend to move toward the node, or (ii) there being an antinode in the center of the fluid channel 105 and the particles being ones that tend to move toward the antinode.

Similarly, FIG. 3B shows three particle streams 305, each centered on a respective node (the particles being ones that tend to move toward a node) or on a respective antinode (the particles being ones that tend to move toward an antinode). FIG. 3C similarly shows four particle streams 305, each centered on a respective node (the particles being ones that tend to move toward a node) or on a respective antinode (the particles being ones that tend to move toward an antinode).

FIG. 3D shows five particle streams, including (i) a first stream 305 of a first kind of particles which tend to move toward a node (which is at the center of the fluid channel 105) and four second streams 310 of a second kind of particles (which tend to move toward the antinodes (which occur at four locations around the central node)) or (ii) a first stream 305 of a first kind of particles which tend to move toward an antinode (which is at the center of the fluid channel 105) and four second streams 310 of a second kind of particles (which tend to move toward the nodes (which occur at four locations around the central antinode). The configuration of FIG. 3D may be used to separate, into separate streams, particles with different properties. The separation of a stream of particles into spatially separated streams within a fluid channel 105 may be referred to herein as aerosol separation.

In some circumstances the nodes may have the shape of lines in the cross-section of the fluid channel 105, as shown in FIG. 3E, in which each of four streams 305 of particles (which tend to move toward the antinodes) is centered on a respective antinode. In some embodiments the shape of a node or antinode may be distributed and irregular, as, for example, in FIG. 3F, in which the stream of particles 305 has a shape, in cross section, that is irregular.

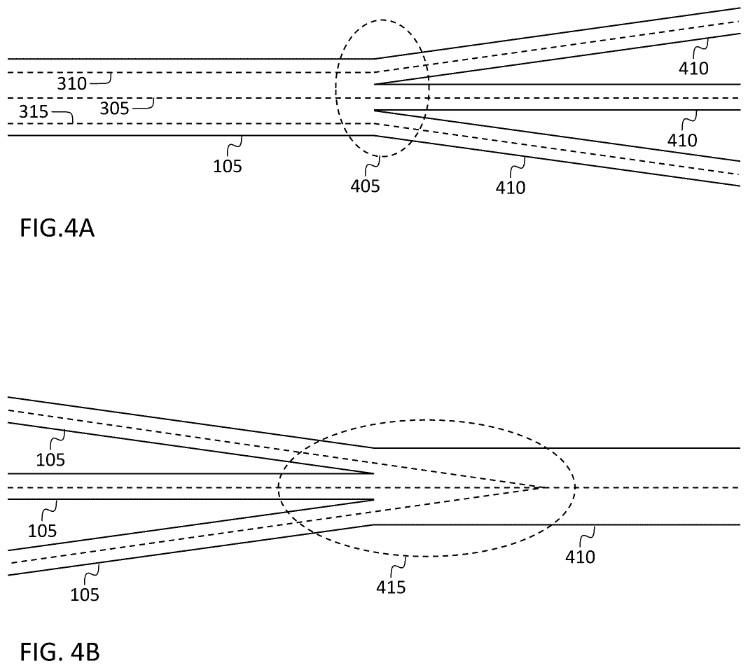

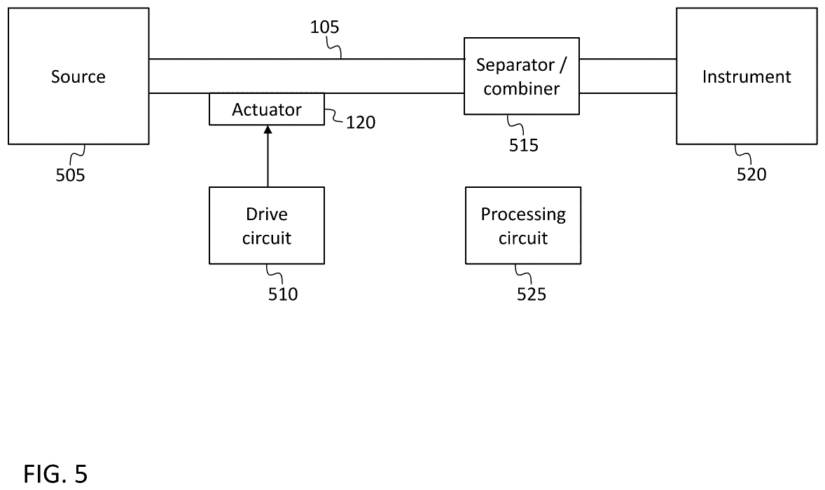

FIG. 4A shows an embodiment in which a first fluid channel 105 has within it three streams of particles 305, 310, 315, which may be separated according to their respective properties. The particles flow from left to right, in FIG. 4A, and at a separator 405, which is a junction, between the first fluid channel 105 and three second fluid channels 410, the three streams of particles flow into three respective fluid channels. In some embodiments, the separator has more than three, or fewer than three, outlets. In some embodiments, an analytic instrument 520 (FIG. 5) is connected to one of the second fluid channels 410, and the outputs of the other second fluid channels 410 are discarded or fed into different instruments. In some embodiments, the frequency or amplitude of the drive signal is varied with time, so that a different one of the input streams is routed to the analytic instrument 520 at different times. In some embodiments, multiple piezoelectric actuators 120 are positioned along the fluid channel 105, with each of the piezoelectric actuators 120 producing a different acoustic transverse mode shape; such an embodiment may provide greater flexibility for routing different streams of aerosol particles to different destinations.

FIG. 4B shows an embodiment with a combiner 415. The combiner 415 is a junction between three first fluid channels 105 and a second fluid channel 410. In the embodiment of FIG. 4B, the three respective streams of particles in the three first fluid channels 105 are merged into a single stream. In some embodiments, more or fewer than three input streams are present in respective first fluid channels 105. The input streams may include (e.g., consist of) different chemical species, and the output of the combiner may be fed to an analytic instrument, to analyze, e.g., products of reactions between the different chemical species, e.g., intermediate products in such reactions. In some embodiments, the analytic instrument is or includes an instrument for analyzing intermediate reaction products, e.g., the analytic instrument is or includes an instrument (e.g., an instrument including an X-ray free-electron laser) for performing time-resolved serial femtosecond crystallography.

FIG. 5 is a system level diagram of a system including an acoustic-focusing enabled system for aerosol control. A source 505 of gas with suspended aerosol particles feeds the gas and aerosol particles into a fluid channel 105 fitted with an actuator (e.g., a piezoelectric actuator) 120 driven by an actuator drive circuit 510. Within the fluid channel 105, due to the effect of acoustic waves produced in the fluid channel 105 by the piezoelectric actuator 120, the aerosol particles may be focused into one or more narrow streams, as described above. The focused stream or streams may be fed into a separator or combiner 515, which may be or include a separator 405 or a combiner 415, or a gas skimmer (for removing some or all of the gas carrying the aerosol particles). The outlet of the separator or combiner 515 may be fed into an analytic instrument 520. In some embodiments, the separator or combiner 515 is absent, and the stream of particles is fed directly from the fluid channel 105 into the analytic instrument 520. A processing circuit 525 (discussed in further detail below) may be connected to one or more of the other elements of FIG. 5. The processing circuit 525 may, for example, (i) control the source 505 (to cause it to feed, or to cease feeding, gas and aerosol particles into the fluid channel 105), (ii) control the frequency or the amplitude of the drive signal produced by the actuator drive circuit 510, or (iii) control, or read data from, the analytic instrument 520.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the word “or” is inclusive, so that, for example, “A or B” means any one of (i) A, (ii) B, and (iii) A and B.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Although exemplary embodiments of a system and method for controlling the flow of aerosols have been specifically described and illustrated herein, many modifications and variations will be apparent to those skilled in the art. Accordingly, it is to be understood that a system and method for controlling the flow of aerosols constructed according to principles of this disclosure may be embodied other than as specifically described herein. The invention is also defined in the following claims, and equivalents thereof.

What is claimed is:

1. A system, comprising:
a fluid channel;
an actuator; and
an actuator drive circuit,
the actuator and the actuator drive circuit being configured to impart vibrations, to a wall of the fluid channel, which produce waves in a gas in the fluid channel and cause aerosols in the gas to be nonuniformly distributed across the interior of the fluid channel,
the waves producing a pressure pattern comprising a plurality of nodes or a plurality of antinodes within the fluid channel.

2. The system of claim 1, wherein the waves produce a pressure pattern comprising a node within the fluid channel.

3. The system of claim 1, wherein the waves produce a pressure pattern comprising an antinode within the fluid channel.

4. The system of claim 1, wherein the waves produce a pressure pattern comprising three nodes within the fluid channel.

5. The system of claim 1, wherein the waves produce a pressure pattern comprising three antinodes within the fluid channel.

6. The system of claim 1, wherein the actuator is a piezoelectric actuator.

7. The system of claim 6, wherein the fluid channel is cylindrical.

8. The system of claim 6, wherein the actuator is a cylindrical piezoelectric actuator.

9. The system of claim 1, wherein the actuator drive circuit is configured to produce a signal with a frequency between 100 KHz and 1.5 MHz.

10. A system, comprising:
a fluid channel;
an actuator;
an actuator drive circuit; and
an analytic instrument,
the actuator and the actuator drive circuit being configured to impart vibrations, to a wall of the fluid channel, which produce waves in a gas in the fluid channel and cause aerosols in the gas to be nonuniformly distributed across the interior of the fluid channel, and
an outlet of the fluid channel being connected to the analytic instrument.

11. The system of claim 10, wherein the analytic instrument comprises a mass spectrometer.

12. The system of claim 11, wherein the mass spectrometer is a quadrupole ion trap mass spectrometer.

13. The system of claim 10, wherein the analytic instrument comprises a system for performing crystallography.

14. The system of claim 10, wherein the waves produce a pressure pattern comprising a node within the fluid channel.

15. The system of claim 10, wherein the waves produce a pressure pattern comprising an antinode within the fluid channel.

16. The system of claim 10, wherein the waves produce a pressure pattern comprising three antinodes within the fluid channel.

17. The system of claim 10, wherein the actuator is a piezoelectric actuator.

18. The system of claim 17, wherein the fluid channel is cylindrical.

19. The system of claim 17, wherein the actuator is a cylindrical piezoelectric actuator.

20. The system of claim 10, wherein the actuator drive circuit is configured to produce a signal with a frequency between 100 KHz and 1.5 MHz.
